(19) United States
(12) Patent Application Publication
(10) Pub. No.: US 2007/0105443 A1
(43) Pub. Date: May 10, 2007

(54) SINGLE ADAPTER FOR CONNECTING A WIRE PULLER TO A CONDUIT OF ANY OF A VARIETY OF SIZES

(76) Inventor: Brian Ray, Gilbert, AZ (US)

Correspondence Address: SCHMEISER OLSEN & WATTS, 18 E UNIVERSITY DRIVE, SUITE # 101, MESA, AZ, 85201, US

(21) Appl. No.: 11/552,852

(22) Filed: Oct. 25, 2006

Related U.S. Application Data
(60) Provisional application No. 60/730,672, filed on Oct. 26, 2005.

(51) Int. Cl. H01R 9/03

(52) U.S. Cl. 439/610

(57) ABSTRACT

An adapter for connecting pullers to conduits of a variety of sizes includes a flexible cable for surrounding the conduit. A surrounding portion of the cable can be adjusted to any desirable length. In one embodiment, the adapter includes a connection plate that has a spring loaded cable connected at one side edge of the plate and a notch at an opposite edge of the plate. The cable includes stop lugs at positions along the cable corresponding to conduits of a variety of sizes. The cable surrounds the conduit and a portion of the cable adjacent to one of the lugs is engaged in the notch. In another embodiment, the connection plate includes a hook at one side edge and a one-way stop mechanism at the opposite side edge. The cable is connected to the connection plate on the hook at one end and the other end of the cable passes through the stop mechanism. The surrounding length of the cable may be shortened by pulling the cable through the stop mechanism and may be lengthened by releasing a lever of the stop mechanism.

This application claims priority to U.S. Provisional Patent Application Ser. No.: 60/730,672 filed Oct. 26, 2005, entitled SINGLE ADAPTER FOR CONNECTING A WIRE PULLER TO A CONDUIT OF ANY OF A VARIETY OF SIZES, by Brian Ray the disclosure of which is incorporated herein by reference.

### BACKGROUND OF THE INVENTION

1. Technical Field

This invention generally relates to adapters for connecting cable or wire pullers to an end of a conduit through which the cable or wire is to be pulled, and specifically to adapters for connecting pullers to conduits of a variety of sizes.

2. State of the Art

Adapters of the past have a plurality of adapter elements corresponding to a respective plurality of conduit sizes. A user thus selects from among these adapter elements to match a conduit of a particular diameter. Then the user attaches the selected adapter element to the puller and to the conduit through which a cable or wire is to be pulled.

Other adapters are capable of engaging conduit of a variety of sizes with the same adapter element. These other adapters have a chain having dual parallel links, the surrounding length of which chain may be adjusted.

### DISCLOSURE OF THE INVENTION

The present invention relates to adapters for connecting wire pullers to conduits, and particularly to connectors or conduits near an end of a conduit through which wire is to be pulled.

In a simple form, an adapter in accordance with the present invention may include a puller connection plate having a first planar portion extending in a longitudinal direction corresponding to a direction of pulling. The puller connection plate may have a first longitudinal end and a second longitudinal end opposite the first longitudinal end. A flexible cable may be removably and adjustably connected to the connection plate. A lip or lip engaging element may extend transversely relative to the first planar portion and may define a second planar portion having a generally V-shaped edge.

The lip may be located at the second longitudinal end of the puller connection plate. The generally V-shaped edge may face away from the first planar portion. The flexible cable may be connected to the connection plate adjacent to the second longitudinal end. The flexible cable may be connected at each of first and second lateral sides of the connection plate.

In a first embodiment, the adapter may further include a spring loaded coupling at the first lateral side and a notch at the second lateral side. The notch may have a reentrant portion. The cable may have a plurality of lugs fixed at predetermined positions along a surrounding length of the cable, wherein a sum of a respective distance from a first end of the cable to a respective lug and the lateral width of the connection plate generally corresponds to a respective circumference of the conduit to which the connection plate is to be attached.

In a second embodiment, the adapter may further include a hook supported at the first lateral side and a one-way stop mechanism supported at the second lateral side. The one-way stop mechanism may have a through opening through which the flexible cable adjustably passes. The one-way stop mechanism may be configured to inhibit movement of the cable in a surrounding-length increasing direction and to permit sliding of the cable in a surrounding length shortening direction.

In another simple form, the present invention may include a method of connecting a wire puller to a conduit. This method may include: attaching a puller connection plate to a puller; connecting the puller connection plate to an end of a conduit by: 1. engaging a lip of the connection plate on a lip of a connector or electrical box attached to the conduit, 2. surrounding the connector or conduit with a surrounding portion of the cable, and 3. adjusting a length of the surrounding portion of the cable relative to the connection plate to firmly engage the connector or conduit.

The step of surrounding may include surrounding threads of the connector or the conduit. The step of surrounding may include surrounding the connector or conduit in a second plane perpendicular to the conduit, which second plane is offset from a first plane that is perpendicular to the conduit and extends through points of connection of the cable on the connection plate. This is enabled by the cable being flexible about multiple axes at each point along the length of the cable.

In the first embodiment, the step of adjusting may include pulling the cable against the bias of a spring at the first end of the cable and engaging a portion of the cable adjacent one of the lugs in the notch, and releasing the cable so that the spring urges the cable into a taught surrounding relation to the connector or conduit.

In the second embodiment, the step of adjusting may include releasing a lever of the stop mechanism to permit lengthening of a surrounding length of the cable. The step of adjusting may include pulling the cable and sliding the cable in a shortening direction through the one-way stop mechanism.

The foregoing and other features and advantages of the present invention will be apparent from the following more detailed description of the particular embodiments of the invention, as illustrated in the accompanying drawings.

### BRIEF DESCRIPTION OF THE DRAWINGS

FIG. 1 is a perspective view of a wire puller attached to a conduit;

FIG. 2 is an enlarged view of the attachment point between the wire puller and the conduit;

FIG. 3 is a perspective view of an adapter attached to a conduit and a bracket of a wire puller according to the first embodiment of the present invention;

FIG. 4 is a perspective view of the adapter according to the first embodiment of the present invention;

FIG. 5 is a perspective view of an adapter attached to a conduit according to a second embodiment of the present invention;

FIG. 6 is a side perspective view of the adapter attached to the conduit according to the second embodiment of the present invention; and

FIG. 7 is an enlarged perspective view of a one-way stop mechanism.

### DETAILED DESCRIPTION OF EMBODIMENTS OF THE INVENTION

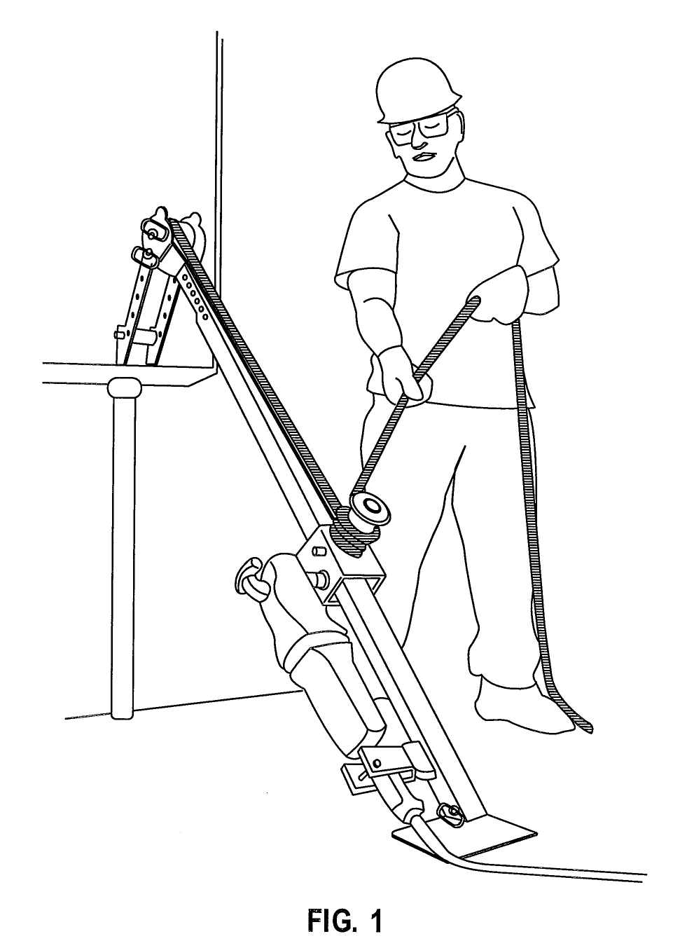

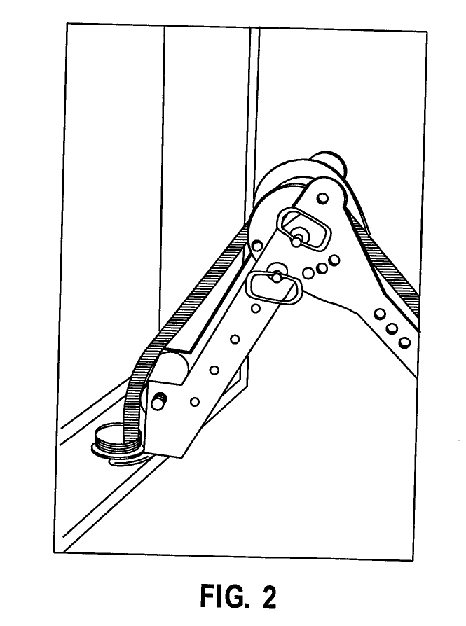

As discussed above, embodiments of the present invention relate to wire pullers and adapters as applied conventionally in FIGS. 1 and 2. The adapter of the present invention is for securing a wire puller to an end of a conduit such as in an electrical box similar to the application shown in FIG. 1. The connection is made by abutting an adapter on a lip of a connector or an electrical box wall supported on the lip, and by tightening a ring nut on an upper surface of the adapter as conventionally applied and shown in FIG. 2.

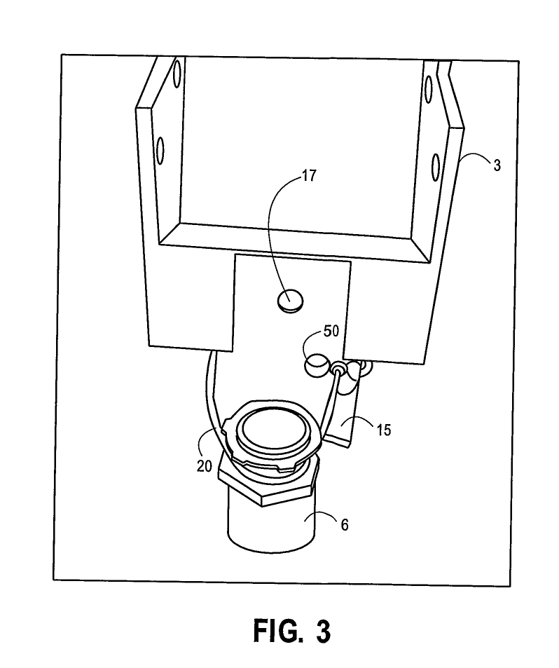

There are two embodiments of the adapter of the present invention, one of which is shown connecting an end bracket 3 of a puller to a conduit connector 6 in FIG. 3.

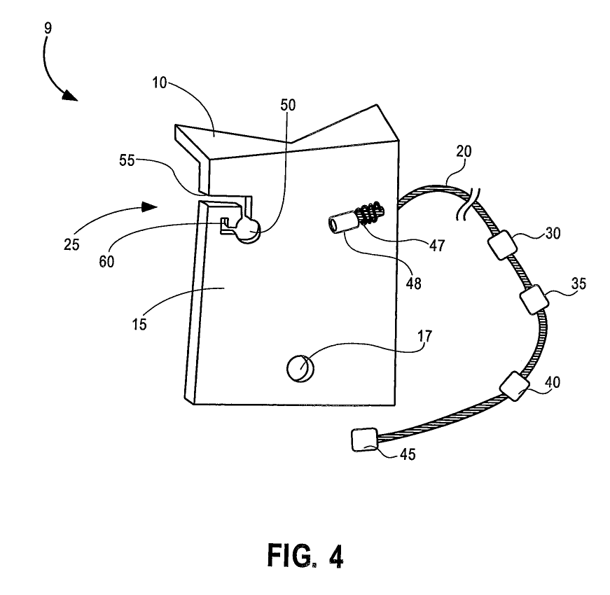

In the first embodiment, also shown in FIG. 4, a device in accordance with the invention is a connection plate 9 that has a lip or lip engaging piece 10 for engaging a lip of a connector attached to an end of a conduit through which wires are to be pulled. The lip or lip engaging piece 10 forms part of a puller connection plate 9. A first planar portion 15 of the puller connection plate 9 may support the lip 10 and rigidly extend therefrom for connection with a puller. In the embodiment of FIG. 4, the puller connection plate 9 extends at a ninety degree angle relative to the lip or lip engaging piece 10. A hole 17 or other connection structure may be used to rigidly connect the connection plate 9 to the puller.

The puller connection plate 9 has a spring loaded cable 20 connected at one side edge of the plate 9 and a notch 25 at an opposite side edge of the plate. The cable 20 has a plurality of stop lugs 30, 35, 40, 45 at positions along the cable 20 corresponding to conduits/connectors of the variety of sizes. Thus, one adapter may be used to secure a puller to a conduit of any of a variety of sizes. For example, the stop lugs may be placed for securely surrounding any of a set of conduits/connectors of 1″, 1¼″, 1½″, 2″, 2½″, 3″, 3½″, 4″, 5″, 6″, and/or other sizes.

A spring 47 surrounding the cable 20 engages an end lug 48 on one end of the spring 47 and the plate 9 on the other end to bias the cable in a shortening direction with regard to an effective conduit surrounding length. Thus, the cable may be pulled against a bias of the spring 47 in order to get one of the lugs to extend past a plane of the plate 9 and the cable 20 to lock into the notch 25 when surrounding a conduit/connector of a particular size corresponding to one of the lug positions. As such, the cable 20 and the lip or lip engaging piece 10 form a secure surrounding structure that holds the lip or lip engaging piece 10 against a lip near an end of the conduit/connector through which wire is to be pulled. It is to be understood that the connections of the cable to the plate 9 may be adjacent to a second end of the plate 9. Adjacent in this case may be taken to mean in a range from zero to one eighth inch from a second longitudinal end of the plate. Alternatively, adjacent may be taken to mean from zero to three eighths of an inch from the second longitudinal end. Further alternatively, adjacent may be taken to mean from zero to three quarters of an inch from the second longitudinal end. Still further alternatively, adjacent may be taken to mean from zero to one and a quarter inches from the second longitudinal end. It is to be understood that proportionally adjacent for plates applied to larger conduits may be further from the second longitudinal end, yet be relatively near to the second longitudinal end as opposed to the first longitudinal end. Thus, the cable may be connected at any distance from the second end within these ranges or outside of these ranges as generally proportionally shown in the Figures.

The notch 25 may have an enlarged or reentrant portion 50 intermediately positioned between a cable insertion opening 55 at an edge of the plate 15 and a locking slot 60. Thus, the cable need not be completely removed from the notch 25 when adjusting its effective length. Rather, the lugs may be passed through the enlarged portion 50 when a user desires to shorten or lengthen the effective length of the cable 20.

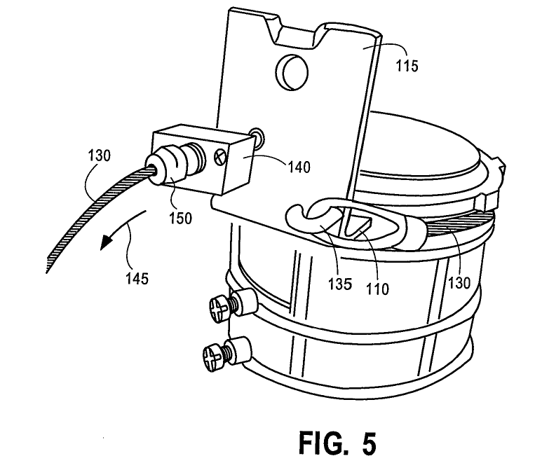

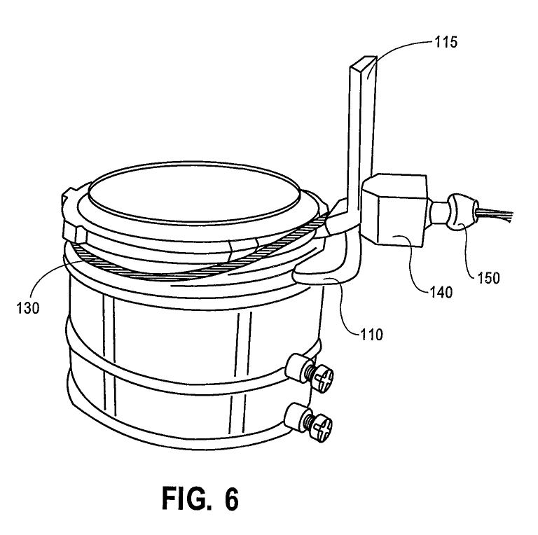

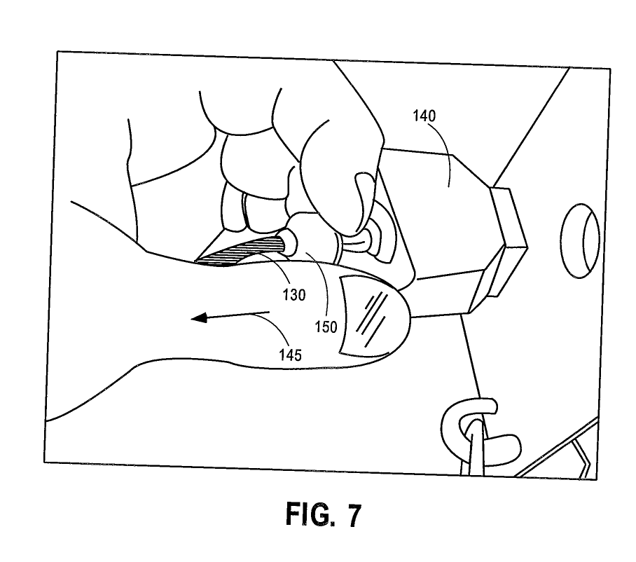

In a second embodiment shown in FIGS. 5-7 that functions similarly and has a lip or lip engaging piece 110 and a puller connection plate 115 similar to the first embodiment, the cable 130 has no stop lugs. Rather, the cable 130 is attached by a loop at one end engaged on a hook 135 supported on the puller connection plate 115 and the cable 130 is wrapped around the threads of the connector. The cable 130 is threaded through a one-way stop mechanism 140 supported on an opposite side of the puller connection plate 115. The cable 130 can easily be pulled through the one-way stop mechanism 140 in a direction of arrow 145, as shown in FIGS. 5 and 7. On the other hand, the mechanism 140 stops or inhibits movement of the cable 130 in the opposite direction. Thus, the adapter of the second embodiment can be fitted to conduits/conduit connectors of any of a variety of sizes similar to that described above with regard to the first embodiment.

To release the cable 130 for loosening and removing the adapter from the connector, a lever 150 is pulled in a direction of arrow 145, as shown in FIG. 7.

It should be noted that the notch is configured to direct a dangling portion away from exposed terminal ends of wiring in a box when performing an overhead pull, for example.

In one aspect, the present invention has a cable that engages a hook at one side edge of the puller connection plate and passes through a one-way stop mechanism at the other side edge for infinite surrounding length adjustment along the length of the cable for selectively connecting a puller to any of a variety of sizes of conduit or connectors via a single adapter comprising a puller connection plate and the cable. The one-way stop mechanism provides a simple way for adjusting the surrounding length to an infinite variety of lengths along the cable.

The flexibility of the cables of the present invention is advantageous. That is the cables are flexible about infinite axes that are transverse to the longitudinal axis of the cable. This enables the cable to be moved out of a plane when being engaged around a conduit. The cable may be connected to the connection plate on a first plane and the cable may surround the conduit on a second plane. The first and second planes may be essentially parallel to each other and offset from each other. Thus, the present invention enables connection of a puller to a very short end of a conduit that protrudes into an electrical box or to the threads of a nipple on a connector even though the connection plate is generally or completely offset relative to the short end.

The embodiments and examples set forth herein were presented in order to best explain the present invention and its practical application and to thereby enable those of ordinary skill in the art to make and use the invention. However, those of ordinary skill in the art will recognize that the foregoing description and examples have been presented for the purposes of illustration and example only. The description as set forth is not intended to be exhaustive or to limit the invention to the precise form disclosed. Many modifications and variations are possible in light of the teachings above without departing from the spirit and scope of the present invention.

What is claimed is:

1. An adapter for connecting a wire puller to a conduit, the adapter comprising:
a puller connection plate having a first planar portion extending in a longitudinal direction corresponding to a direction of pulling, the puller connection plate having a first longitudinal end and a second longitudinal end opposite the first longitudinal end;
a flexible cable removably and adjustably connected to the connection plate; and
a lip extending transversely relative to the first planar portion and defining a second planar portion having a generally V-shaped edge.

2. The adapter of claim 1, wherein the lip is located at the second longitudinal end of the puller connection plate.

3. The adapter of claim 1, wherein the generally V-shaped edge faces away from the first planar portion.

4. The adapter of claim 1, wherein the flexible cable is connected to the connection plate adjacent to the second longitudinal end of the connection plate.

5. The adapter of claim 1, wherein the flexible cable is connected at each of a first lateral side and a second lateral side of the connection plate.

6. The adapter of claim 5, wherein the adapter further comprises a spring loaded coupling at the first lateral side and a notch at the second lateral side.

7. The adapter of claim 6, wherein the notch has a reentrant portion.

8. The adapter of claim 1, wherein the cable has a plurality of lugs fixed at predetermined positions along a surrounding length of the cable, wherein a sum of a respective distance from a first end of the cable to a respective lug and a lateral width of the connection plate generally corresponds to a respective circumference of the conduit to which the connection plate is to be attached.

9. The adapter of claim 5, wherein the adapter further includes a hook supported at the first lateral side and a one-way stop mechanism supported at the second lateral side.

10. The adapter of claim 9, wherein the one-way stop mechanism has a through opening through which the flexible cable adjustably passes.

11. The adapter of claim 9, wherein the one-way stop mechanism is configured to inhibit movement of the cable in a surrounding length increasing direction and to permit sliding of the cable in a surrounding length shortening direction.

12. A method of connecting a wire puller to a conduit comprising:
attaching a puller connection plate to a puller;
connecting the puller connection plate to an end of a conduit by:
engaging a lip of the connection plate on a lip of a connector or electrical box attached to the conduit;
surrounding the connector or the conduit with a surrounding portion of a cable; and
adjusting a length of the surrounding portion of the cable relative to the connection plate to firmly engage the connector or the conduit.

13. The method of claim 12, wherein the step of surrounding includes surrounding threads of the connector or the conduit.

14. The method of claim 12, wherein the step of surrounding includes surrounding the connector or conduit in a second plane perpendicular to the conduit, which second plane is offset from a first plane that is perpendicular to the conduit and extends through points of connection of the cable on the connection plate.

15. The method of claim 12, wherein the connection plate comprises a hook supported at a first lateral side of the connection plate and a one-way stop mechanism through which the cable passes supported at a second lateral side of the connection plate.

16. The method of claim 15, wherein the step of adjusting includes releasing a lever of the stop mechanism to permit lengthening of a surrounding length of the cable.

17. The method of claim 15, wherein the step of adjusting includes pulling the cable in a shortening direction through the one-way stop mechanism.

18. The method of claim 12, wherein the connection plate comprises a spring at a first lateral side of the connection plate and a notch at a second lateral side of the connection plate.

19. The method of claim 18, wherein the surrounding portion of the cable comprises a plurality of lugs fixed at predetermined portions along the surrounding portion.

20. The method of claim 19, wherein the step of adjusting includes pulling the cable against a bias of the spring at a first end of the cable and engaging a portion of the cable adjacent one of the lugs, in the notch, and releasing the cable so that the spring urges the cable into a taught surrounding relation to the connector or conduit.
